(19) United States
(12) Patent Application Publication
(10) Pub. No.: US 2012/0059717 A1
(43) Pub. Date: Mar. 8, 2012

(54) User List Generation and Identification

(75) Inventors: Vadim Furman, San Jose, CA (US); Anurag Agarwal, Sunnyvale, CA (US); Rajas Moonka, San Ramon, CA (US)

(73) Assignee: GOOGLE INC., Mountain View, CA (US)

(21) Appl. No.: 13/221,541

(22) Filed: Aug. 30, 2011

Related U.S. Application Data
(60) Provisional application No. 61/379,278, filed on Sep. 1, 2010.

(51) Int. Cl. G06Q 30/02

(52) U.S. Cl. 705/14.53; 705/14.49

(57) ABSTRACT

Methods, systems, computer program products and techniques are described for presenting content. One method includes generating, by a data exchange engine executing on one or more processors, one or more user lists based on owned or permissioned data; importing, by the data exchange engine, user specific data from at least one of a browser, a third-party server, or an advertising database; generating, by the data exchange engine, one or more associations between one or more user lists and the imported user specific data, wherein the associations define whether user specific data correlates to one or more predefined definitions associated with a given user list; storing the associations; and providing user list identifying information to subscribers to a given user list in response to receipt of a content request from a user included in a respective user list.

### CROSS-REFERENCE TO RELATED APPLICATION

This application claims priority to U.S. Provisional Application No. 61/379,278, filed on Sep. 1, 2010. The disclosure of the prior application is considered part of and is incorporated by reference in the disclosure of this application.

### TECHNICAL FIELD

This document relates to presenting content.

### BACKGROUND

Providing relevant advertising content to users is generally important to advertisers and service providers. However, implementing a cost-effective way of providing such relevant advertising content can prove difficult in an ever-changing online market. Further, while relevant information for targeting a particular user may be known by one entity, others may not readily have access to or be able to use such information when, for example, making targeting decisions.

### SUMMARY

This document discusses systems, methods, computer program products and techniques for presenting content. An example computer-implemented method includes generating, by a data exchange engine executing on one or more processors, one or more user lists based on owned or permissioned data; importing, by the data exchange engine, user specific data from at least one of a browser, a third-party server, or an advertising database; generating, by the data exchange engine, one or more associations between one or more user lists and the imported user specific data, wherein the associations define whether user specific data correlates to one or more predefined definitions associated with a given user list; storing the associations; and providing user list identifying information to subscribers to a given user list in response to receipt of a content request from a user included in a respective user list.

The details of one or more embodiments are set forth in the accompanying drawings and the description below. Other features and advantages will be apparent from the description and drawings, and from the claims.

### DESCRIPTION OF DRAWINGS

FIG. 1A is a schematic diagram of an example system for providing and using shared data.

FIG. 1B-H are example user interfaces associated with the system of FIG. 1A.

FIG. 2 is a schematic diagram of example user lists.

FIG. 3 is a flow diagram of an example process for managing user lists.

FIG. 4 is a flow diagram of an example process for using user lists when retrieving or customizing advertising content.

FIG. 5 shows an example of a computer device and a mobile computer device that can be used to implement the techniques described here.

Like reference symbols in the various drawings indicate like elements.

### DETAILED DESCRIPTION

Advertisers, publishers, and service providers generally may wish to exchange data for purposes of implementing a meaningful way of providing information and/or services (e.g., advertising content) to online users. If specific content is determined to be meaningful to a particular user, then the user may wish to access the content, purchase the content, or otherwise interact with the content. This interaction can provide revenue to the content provider (e.g., advertiser, publisher or service provider). If a particular content provider (e.g., advertiser, publisher, or service provider) can collect data about how specific content may or may not be meaningful to users (i.e., in the form of a user list), the collected data may be used by others in a variety of ways. One use relates to selecting targeted content. Other uses are possible, such as in adjusting bids in an auction based, for example, on user lists that indicate specific content is of interest to one or more users. User lists can be published, sold, licensed or otherwise accessed to assist in providing personalized content to the specific users and increasing revenue for a content provider.

User lists can represent specific user information pertaining to predefined categories. The categories can be defined by the data owners. For example, a user list may include data about one or more users which characterizes the users to a category (e.g., homeowner, craftsman, DVD renter, etc.) to allow targeting of the users by, for example, publishers or advertisers. In some implementations, the user lists can be used to target relevant advertising content.

User lists can be generated and exchanged according to a number of rules, and those rules can be used to market particular user lists to specific consumers. The rules can employ methods of assigning users to particular user lists. Such rules can provide a logical categorization of data, information, or services for the purposes of determining which data content in the user lists is particularly relevant to a number of users.

Methods are described for associating user specific information with one or more user lists that are owned or maintained by a data owner. An association between the user-specific data and the user lists is made. The association can be exploited, for example, for real-time bidding in response to requests for content or to customize content to be provided to a specific user. Other uses of the user list information and associations are possible.

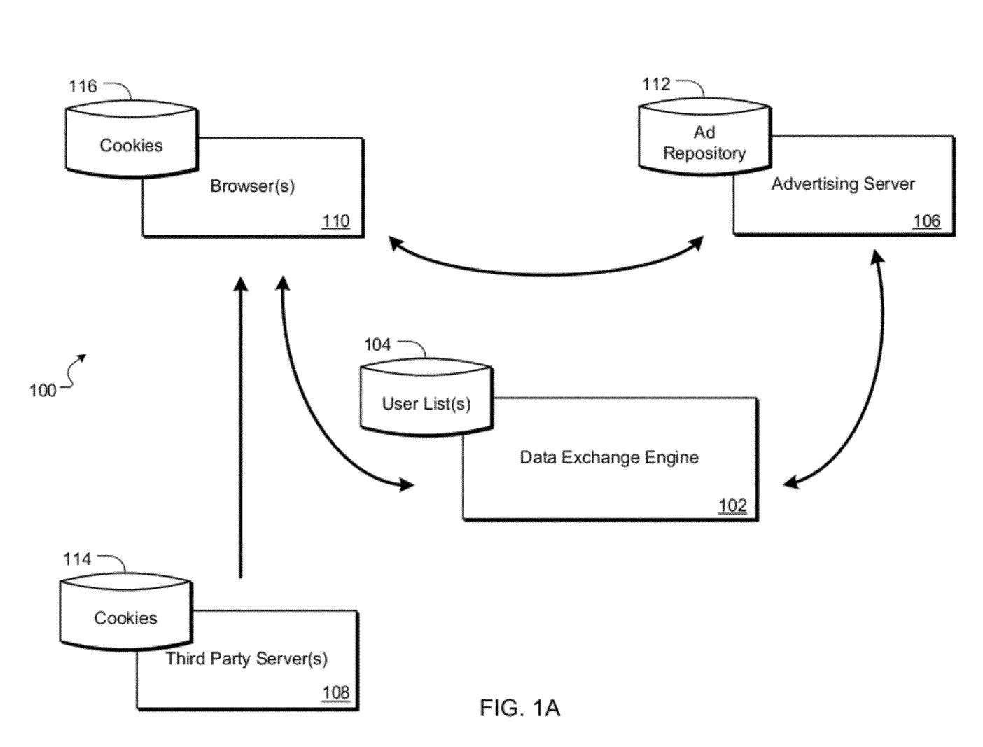

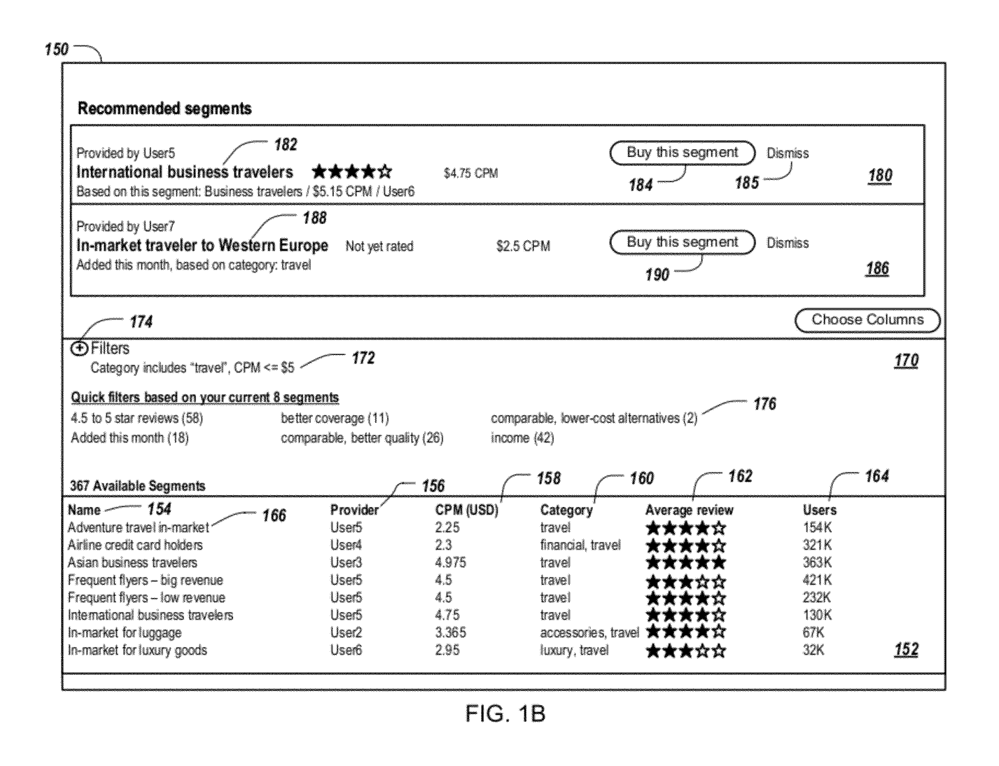

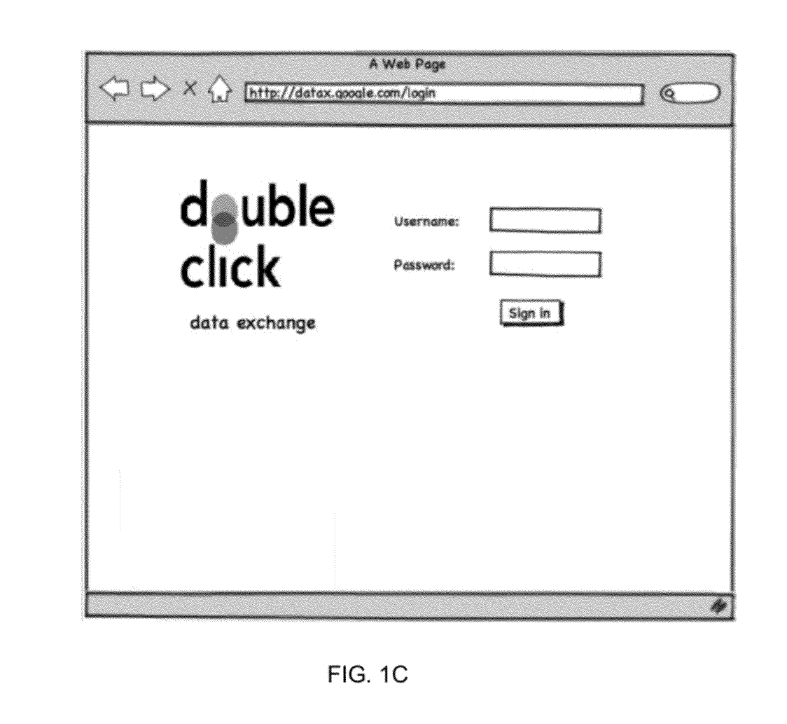

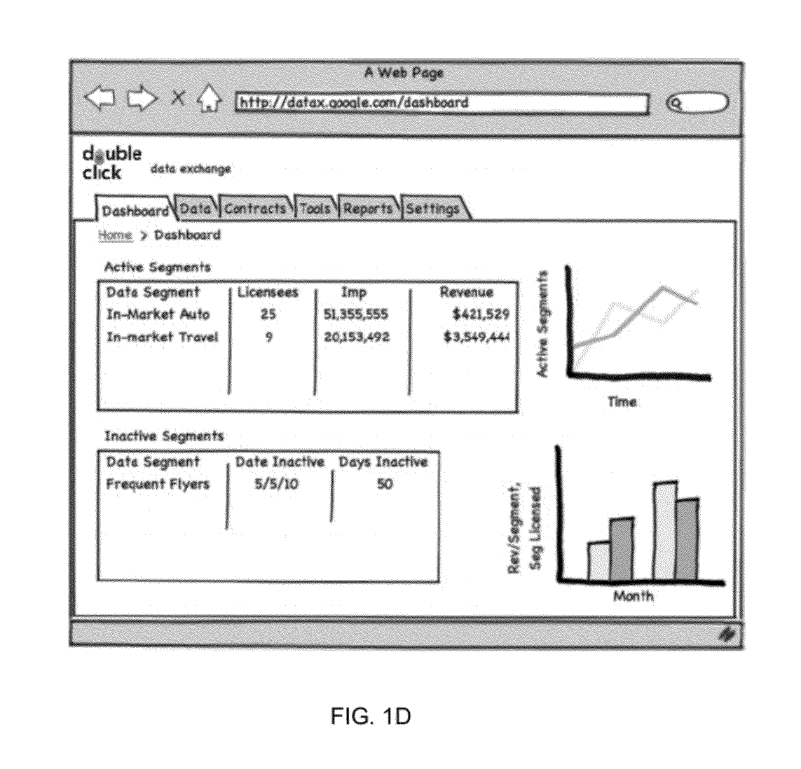

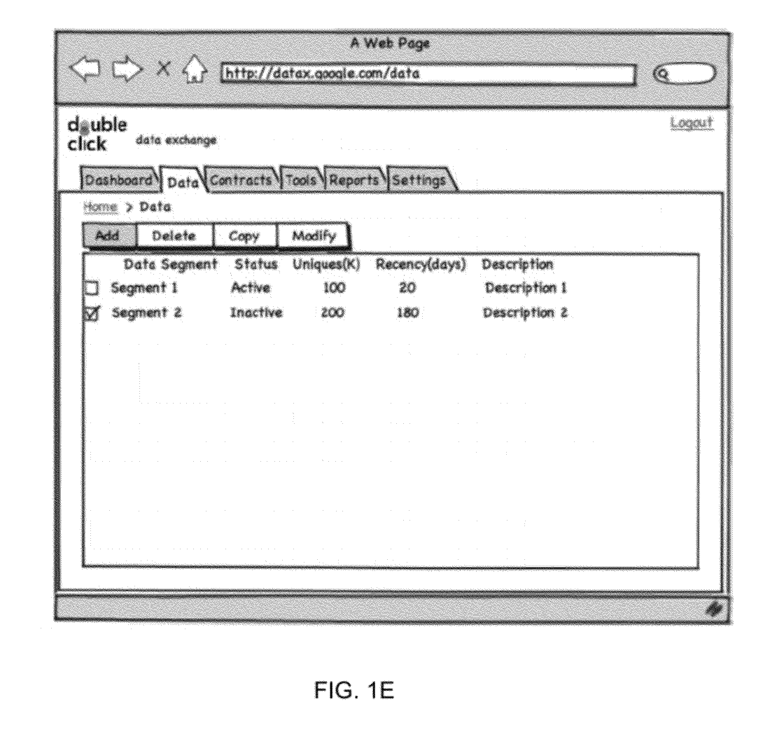

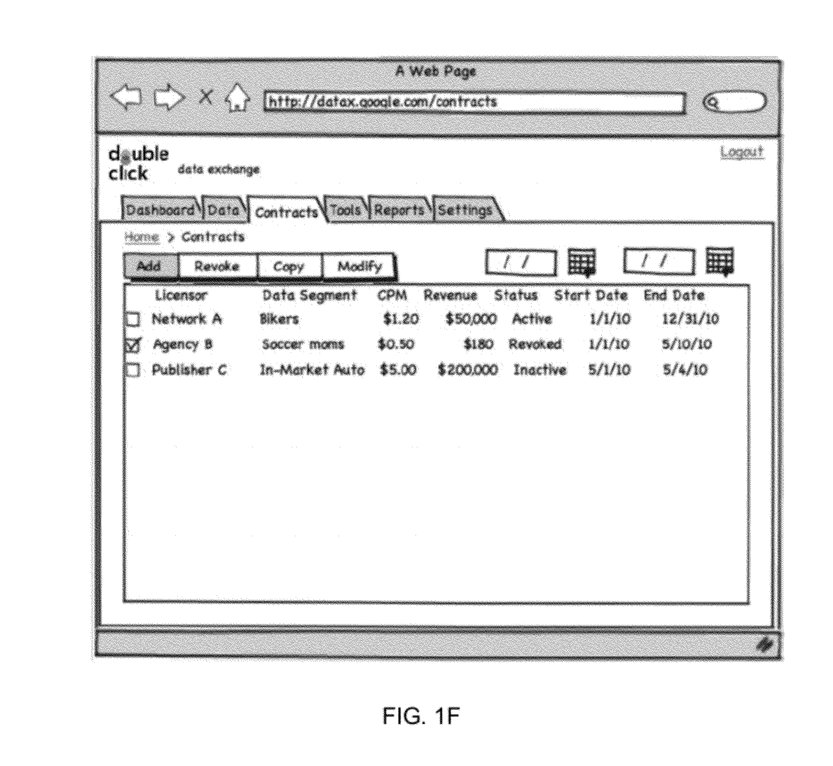

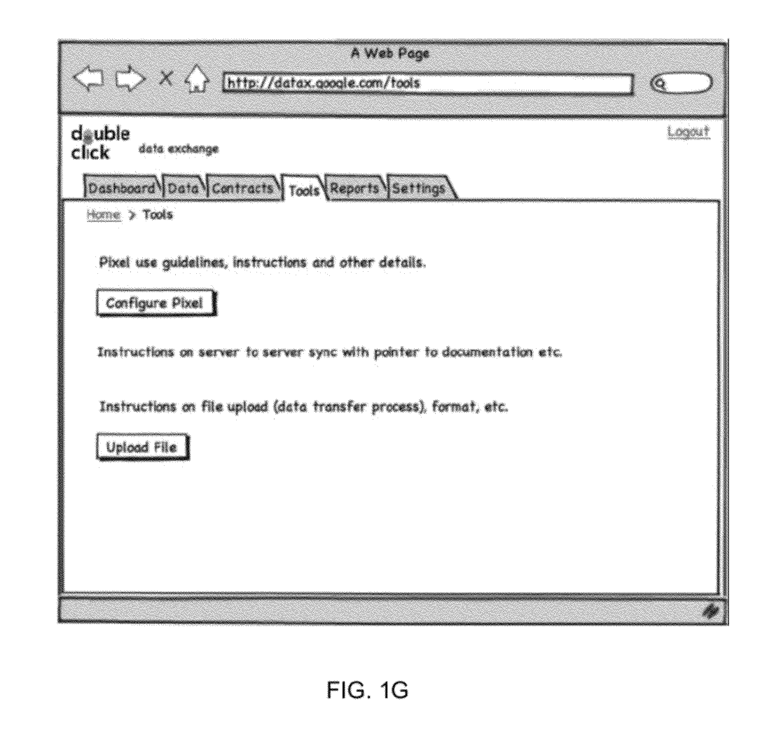

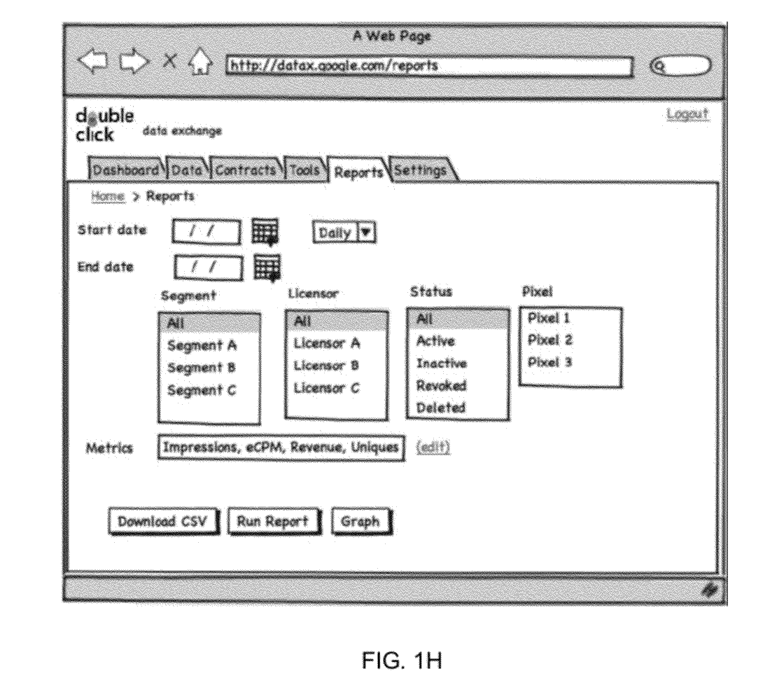

FIG. 1A is a schematic diagram of a system 100 for providing and using shared data. The shared data can, for example, include user lists detailing a number of predefined categories pertaining to specific users. The categories can be defined by or relate to user information including, but not limited to, browser history, user selections, cookie information, user-provided preferences, purchase histories, web search data, or other data (i.e., where the user has provided permission for the storing and/or collecting of such data). In some implementations, a user list is owned by a data provider that gathered the information in a respective user list. In some implementations, the user lists can be shared with other entities, such as for example using a data exchange. For example, the user lists can be shared amongst advertisers, third-party service providers, or third-party advertisers, data aggregators, and other online users.

The user lists can be provided to the data exchange and maintained by the data exchange and/or by the data owners. User lists can be updated as appropriate to either refine the category/categories associated therewith or the users that are members of a given list. Management of user lists is described in greater detail below.

The system 100 includes a data exchange engine 102 for providing an interface for consumers (e.g., advertisers) and others to discover and/or license user lists 104. FIG. 1B shows an example user interface for a marketplace for presenting user lists (also referred to therein as “segments” or “audience segments”). The presented user lists can be all available, all that correspond to one or more filter criteria, those surfaced based on prior use or data provided from a potential consumer or other filter criteria. FIGS. 1C-H show example user interfaces for managing user list subscriptions. FIG. 1C shows a login page for accessing user lists associated with a subscriber account in the marketplace shown in FIG. 1B. FIG. 1D shows an example user interface that includes active and inactive segments associated with a subscriber account. FIG. 1E shows an example of a user interface for managing segments. FIG. 1F shows an example of a user interface showing contract details for subscriptions. FIG. 1G shows an example of a user interface showing tools available for managing a subscription. FIG. 1H shows an example of a user interface for reports associated with a subscription account. The data exchange engine 102 can be configurable to maintain, update, present, license, sell or otherwise manage one or more user lists based on owned or permissioned data. The generated user lists can include user-specific associations characterizing specific online user behavior. The associations can be used, for example, to provide personalized content from an advertising server 106, a third-party server 108, or other content provider. The data exchange engine 102 as described here may parallel the functionality of an online advertisement exchange system for active targeted online advertisers, for example.

In some implementations, the data exchange engine 102 can create an exchange between owners of permissioned data and users of such data. Users of the permissioned data can include advertisers that seek to target particular categories of users. In some implementations, the data exchange engine 102 provides a mechanism for a provider of advertising placement services in targeted online advertising to make available additional third-party data sources to buyers of advertising space. In some implementations, the data exchange engine 102 can provide user lists to publishers, syndicates, and other data providers for various purposes, including the targeting of advertising content to users.

The data exchange engine 102 can provide an interface for data owners to securely view and manage their own data (i.e., manage a user list). For example, a data owner can generate and store information in a user list by entering data both manually and automatically. Other entities may be permitted to enter/maintain information in a user list. Publishers can also extract data for direct sales models or other marketing plans. Although computer hardware is not depicted in the data exchange engine 102, processors, memory, and other processing components may be included.

The advertising server 106 can provide advertising content to any number of browsers 110 via the data exchange engine 102 or directly. In addition, the advertising server 106 can be configurable for receiving advertising content requests and providing advertising content to requesting users. In operation, the advertising server 106 can select advertisements targeted based on one or more criteria and in view of data that is included in one or more user lists. The advertising server 106 can also provide access to other storage elements, such as ad repositories, in the example shown as ad repository 112. The ad repository 112 can be used to store advertising content associated with particular keywords, bidding criteria, advertisers, and targeting criteria. Data storage elements may include any one or combination of methods for storing data, including without limitation, arrays, hash tables, lists, and pairs. The advertising server 106 can access other similar types of data storage devices, such as user lists 104, for example.

In some implementations, advertisers can work with data providers to purchase or license user lists for purposes of targeting certain categories (e.g., demographic categories, interest categories, preference categories). The user lists can be analyzed for quality and other considerations. The advertisers can use the user lists for determining targeting criteria or to modify current bids, for example. In one example use case, an advertiser can subscribe for a period of time to a user list. The user list itself may be defined as being associated with a certain category (e.g., Internet shoppers interested in buying a sports car) of users. Requests for advertisements can be received by the advertising system, and the data exchange can be used to determine for a given user to which user lists the user is subscribed. In a real-time bid example, the advertisers that have subscribed to the user lists may be presented with the request (and necessarily information that the users satisfy the category(ies) associated with the user list(s)), and then may adjust/submit bids in consideration of such information. This is just one example of a use for the user list data.

The third-party servers 108 can provide third-party services to any number of browsers 110 via the data exchange engine 102. For example, the third-party servers 108 can provide web services, advertising services, or external APIs (application programming interfaces) to connect to a third-party server. The third-party servers 108 can include, for example, one or more servers executing a search engine application program. In some implementations, the third-party servers 108 can include a related information server or an advertising server. Third-party servers 108 can track user activity using, for example, cookies 114.

The browser 110 represents a user browsing the Internet. The browser 110 can access any website available on a network belonging to a person, or any other type of entity such as a company, enterprise, etc. For example, in FIG. 1 browser 110 can access a service or website. The service or website can be hosted by the third-party server 108, or alternatively by another server associated with system 100. A user can employ the browser 110 to search the Internet for services, information, or merchandise. The browser 110 can track user activity using cookies 116.

In some implementations, the advertising server 106 includes one or more advertisement customizers (not shown) operable to customize advertising content according to one or more user lists. In particular, an advertisement customizer can customize the display criteria, language, or other content of an advertisement according to user list information. For example, if a particular user list includes user-entered searching pertaining to purchasing a vehicle, the advertising server 106 can use the user-entered searching information (e.g., a cookie stored from performing a web search in a browser) to customize the display or content of an advertisement. The customization can, for example, provide the user with a more relevant advertisement.

In operation and for each generated user list, the system 100 can store, for example in a table-based repository, a list of user lists for which a particular user belongs. The table-based repository can, for example, be represented by a proprietary distributed storage system having a multi-dimensional sorted map as described in the paper entitled “Bigtable: A Distributed Storage System for Structured Data” by Fay Chang, Jeffrey Dean, Sanjay Ghemawat, Wilson C. Hsieh, Deborah A. Wallach, Mike Burrows, Tushar Chandra, Andrew Fikes, and Robert E. Gruber, the content of which is incorporated herein by reference in its entirety. The table-based repository represents a distributed storage system for managing structured data that is designed to scale to a very large size (e.g., petabytes of data across thousands of commodity servers). Each user list in the proprietary database can be included in one or more tables having multiple dimensions (one of which may be a field for time, allowing for versioning and garbage collection).

The system 100 can provide an index to the table-based repository. The index can be represented by, for example, a user cookie. For example, the table-based repository may be a set of rows and columns where the rows represent cookies corresponding to particular users and the columns represent a characterization associated with the user list, such as particular categories, keywords, websites, or other descriptive data.

At some point, the user browser 110 can make a request for advertising content from the advertising server 106 or the third-party server 108. The data exchange engine 102 can retrieve a list of user lists from the table-based repository associated with a received request and append or otherwise associate the list of user lists to the request. Any subsequent processing of the request can use the list, for example, for targeting, advertising customization and bid generation. The list of user lists or portions of the list can also be transmitted to a real-time bidder to provide the bidder with pertinent information about one or more users. Other uses are possible.

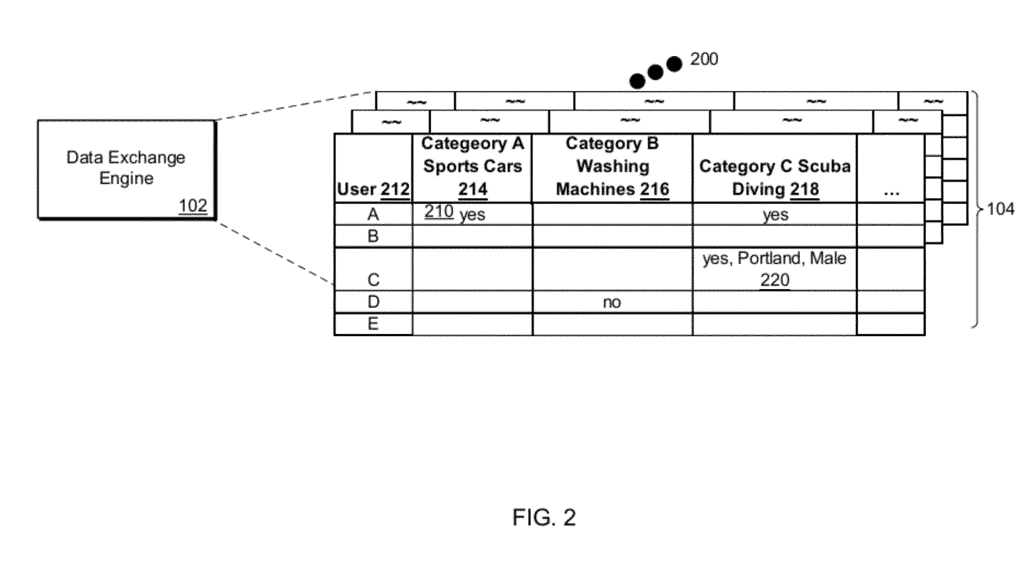

FIG. 2 is a schematic diagram of user lists 104 stored in a table 200. In this example, one or more entities (e.g., a web publishing entity that collected the user data) provided the user lists 104 to the data exchange engine 102. In some implementations, the user lists 104 in the table 200 are all provided by a same entity. Alternatively, the user lists 104 in the table 200 can include user lists owned/associated with different entities. In some implementations, entities can create their own user lists and provide the lists to the data exchange engine 102. For example, entities can format content in user lists according to preferences associated with users and offer the user list data to the data exchange engine 102 for publication, management and use in targeting content to the users. The data in the user lists 104 is developed, for example, based at least in part on user-provided, searching and browser data or other user provided data. In this example, the data exchange engine 102 can manage the user lists 104 which details users 212 A-E.

In this example, each row represents a single user. A user identifier (not shown) can be used to identify a user. The user identifier can be a user identifier associated with a user in a domain associated with the entity that owns/provides the data (i.e., a local identifier). In some implementations, such as those where plural different entities provide user lists that are stored in a single table, the user identifier can be of the form of a global identifier associated with the user, such as an identifier that the advertising system assigns to the user. Global identifiers can be associated with “local” entity identifiers and mapped such that requests that include a local entity identifier can be associated with the global identifier and hence, can be associated with user lists associated with plural entities. Other techniques can be used to identify users, such as cookie-matching technology to allow for the mapping of local identifiers to global identifiers.

Each column represents a user list that includes a characterization (sometimes referred to as a definition), such as by way of a particular category(ies), keyword(s), website(s), demographic(s), interest(s), or other user classification. Example characterizations in the table 200 include sports cars, washing machines, and scuba diving. The characterization can include descriptors, such as keywords, that describe a given category. Each characterization may embody the combination of plural separate categories or subject matter. For example, the characterization sports cars, may embody those individuals that visited a web site that were interested in cars and those that were particularly interested in sports cars (which themselves represent two different categories). In some implementations, logical combinations of categories or subject matter can be used to define the characterization for a given user list.

In some implementations, each entry in the table (i.e., the intersection of a row and a column) represents whether the user is a member of a given list. For example, entry 210 indicates that user A is interested in or associated with a user list that has the characterization of sports cars. In some implementations, other data may be included in the entry. Other data can include geo-location data, cookie data, further personal data related to the user and known by the data owner, example web pages or example content (i.e., content surfed by the user), keyword searches, location data, website data, side vertical data, page vertical data, formatted text strings (where the data owner may include data related to the particular user in accordance with a definition set by the data owner (e.g., a series of bits that are set or not depending on the individual user's data for things like demographics, other interests, or other data that is different from the characterization but may be of use in targeting information to the particular user)) or other data. For example, entry 220 includes an indication that user C is not only a member of the user list associated with category C (scuba diving) but also that the user is located at a particular location (e.g., lives in Portland) and is a member of certain demographic groups (e.g., is male). Other information can be included so as to provide more relevant available information to potential consumers of a given list.

Identification of user lists to which a person belongs can be made by the data exchange engine 102 when a cookie or other user identifiable information is received. In some implementations, the data exchange engine 102 uses the cookie or user identifying information as an index to the user lists 104. For example, the data exchange engine 102 can cross reference received user identifier data with particular user list information to determine an association between user list data and the cookie data/user information. As shown in user lists 104, a user (A) showed an interest in user list A which is characterized by the keywords “sports cars”. For example, the user may, as part of a session with a given data provider, have provided a request to view sports cars made by Lexus such as providing a keyword search for “Lexus sports cars.”

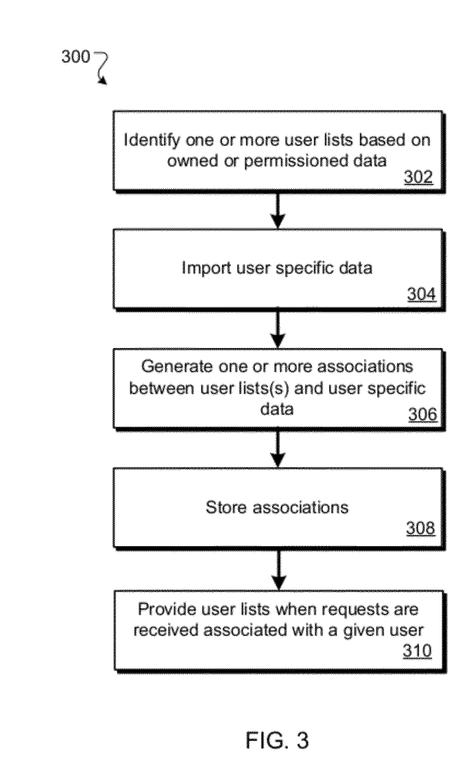

FIG. 3 is a flow diagram of an example process 300 for managing user lists. The process 300 may be executed, for example, by the data exchange engine 102 shown in FIG. 1.

At stage 302, one or more user lists are identified based on owned or permissioned data. The user lists may be user lists 104 and may be provided by one or more entities to the data exchange engine 102. The user lists may be generated by the data exchange engine 102, such as from data provided from data owners or users.

At stage 304, user-specific data is imported. Importing can be performed by the data exchange engine 102. Importing user specific data can include importing user-specific data from at least one of a browser, a third-party server, or an advertising database. While reference is made to importing data, in some implementations, the user specific data can be provided by a data owner or other entity. In some implementations, the user specific data can be provided by a redirect or a cookie. Examples of user specific data include data identifying the user in a local environment or a global environment (such as in an advertiser system). In some implementations, the user specific data is of the form of a global identifier that can be used to identify the user as among plural users of an advertising system. In some implementations, the user specific data is of the form of a global identifier that is associated with a user by an advertising system. In some implementations, a local identifier associated with a user in a particular entity domain is mapped to a global identifier. The global identifier for a given user can be determined as part of the importing process.

In stage 306, one or more associations between one or more user lists and the imported user specific data are made. For example, the data exchange engine 102 can associate a global user identifier with a particular user that is included in a user list associated with a data owner. The associations define whether the user specific data correlates to one or more predefined characterizations associated with given user lists.

In stage 308, the associations in the one or more user lists are stored. For example, the data exchange engine 102 can store plural user lists and associate users in a formatted table-based repository where rows represent an individual user and columns represent a user list.

In stage 310, once a request (i.e., a request for content) is received from a user, one or more user lists to which the user is a member can be identified and then passed along with the request for further processing. For example, the request can be passed on to advertisers that are subscribers to (i.e., either purchased or licensed) of a given user list (e.g., for use in modifying/supplying a bid, or to customize data after an impression has been won).

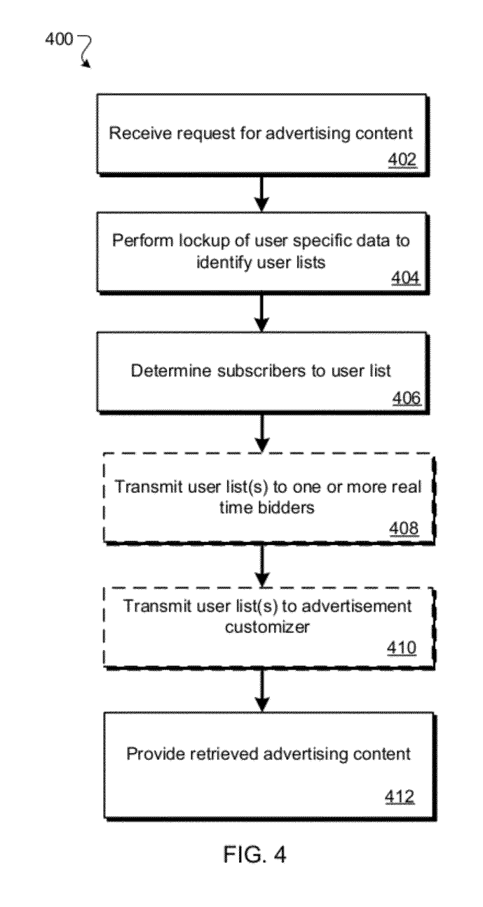

FIG. 4 is a flow diagram of an example process for using user lists to assist in retrieving or customizing advertising content. The process 400 can be executed by, for example, the data exchange engine 102. More or fewer participants may be involved.

At stage 402, a request for content from a user is received. For example an advertisement server 106 executing on one or more processors receives a request for advertising content from a browser 110 executing on a client device and associated with a particular user.

At stage 404, a lookup is performed to determine associated user lists for a given user. For example, the data exchange engine 102 can receive the request from the advertising server 106 along with user-specific data (e.g., a cookie) that identifies the user. The data exchange engine 102 can look up the user lists in the table-based repository using the user specific data, wherein the look up identifies at least one user list that includes a characterization (e.g., targeting criteria) associated with the user specific data.

At stage 406, subscribers to the determined users lists are identified. For example, the data exchange engine 102 can determine one or more entities that have purchased, licensed or subscribed to use a given user list. Alternatively, the data exchange engine 102 can determine one or more candidate entities (such as based on pre-defined advertiser targeting criteria) that may be interested in subscribing to or using the user list data.

At stages 408 and 410, the user list information and the request can be provided to one or more entities for further processing, such as to an advertiser for real-time bidding or an advertisement customizer in association with providing customized content to the user after having won a particular impression associated with the user.

At stage 412, customized content is delivered to the user. For example, the advertising server 106 can use the user list information to assist a bidder in bidding on the impression (i.e., the request). Alternatively, the advertising server 106 can provide the user list to a winning advertiser (that subscribes to the list) for use in customizing content to be provided when servicing the request.

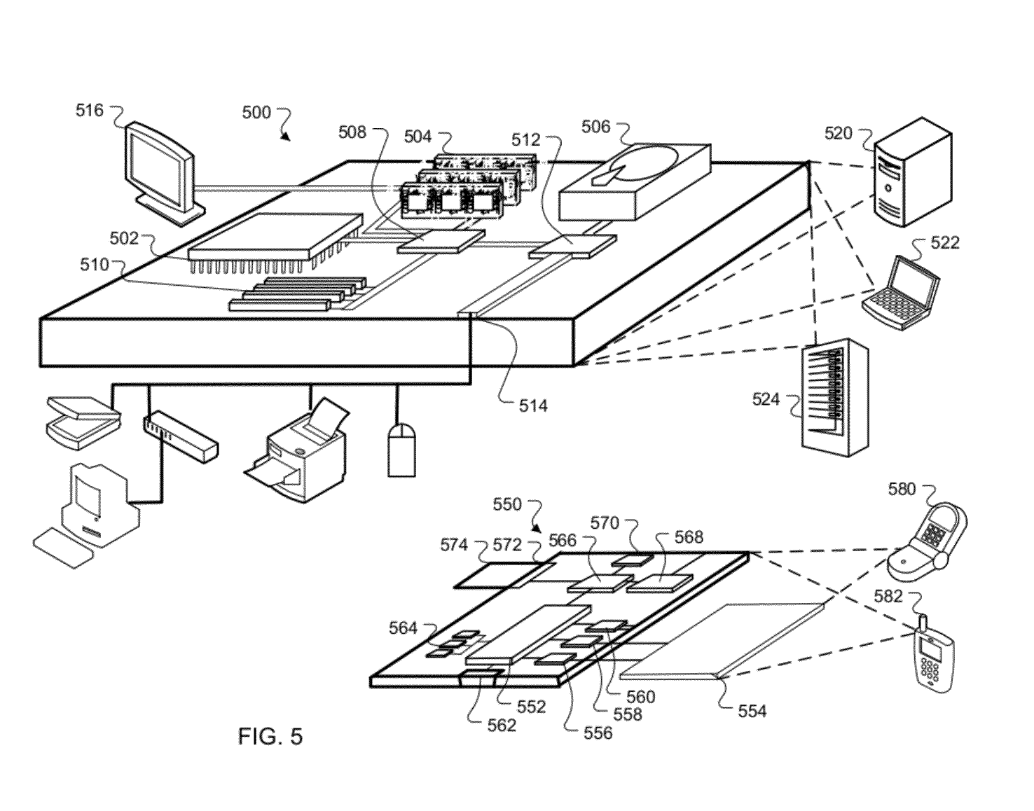

FIG. 5 shows an example of a generic computer device 500 and a generic mobile computer device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. For example, much of this document has been described with respect to advertisements, but other forms of future, content delivery may also be supported.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method, comprising:
generating, by a data exchange engine executing on one or more processors, one or more user lists based on owned or permissioned data;
importing, by the data exchange engine, user specific data from at least one of a browser, a third-party server, or an advertising database;
generating, by the data exchange engine, one or more associations between one or more user lists and the imported user specific data, wherein the associations define whether user specific data correlates to one or more predefined definitions associated with a given user list;
storing the associations; and
providing user list identifying information to subscribers to a given user list in response to receipt of a content request from a user included in a respective user list.

2. The method of claim 1, further comprising:
receiving, by an advertisement server executing on one or more processors, a request for advertising content matching a definition associated with a user list;
performing, by the advertisement server, a lookup in the table-based repository using the user specific data, wherein the lookup identifies at least one user list that includes targeting criteria associated with the user specific data;
retrieving, by the advertisement server, advertising content based on the identified user list; and
providing the retrieved advertising content to a user identified in one or more user lists.

3. The method of claim 1, wherein the user lists are stored in a formatted table-based repository.

4. The method of claim 1, wherein the method further comprising modifying a bid value for one or more user impressions during online bidding using the user list.

5. The method of claim 3, wherein the generated associations between the one or more user lists and the imported user specific data provide an index to a row in the table-based repository.

6. The method of claim 1, wherein the user specific data comprises cookie metadata for the user.

7. The method of claim 1, wherein the user specific data comprises a local identifier of the user in a domain associated with an owner of a respective user list.

8. The method of claim 1, wherein the user specific data comprises a global identifier associated with the user and used by an advertising server that is used to provide ads to the user.

9. The method of claim 3, wherein the table-based repository is a distributed storage system comprising a multi-dimensional sorted map.

10. The method of claim 1, wherein providing the user lists comprises evaluating user list rules to determine subscribers to a user list.

11. The method of claim 1, wherein providing the user lists further comprising transmitting one or more identified user lists to a real-time bidder.

12. The method of claim 1, wherein providing the user lists further comprising transmitting one or more identified user lists to an advertisement customizer.

13. The method of claim 1, further comprising performing advertisement targeting based on one or more user lists.

14. The method claim 1, further comprising performing advertisement customization on retrieved advertising content before providing the advertising content to the user identified in one or more user lists.

15. A computer storage medium encoded with a computer program, the program comprising instructions that when executed by data processing apparatus cause the data processing apparatus to perform operations comprising:
generating one or more user lists based on owned or permissioned data;
importing user specific data from at least one of a browser, a third-party server, or an advertising database;
generating one or more associations between one or more user lists and the imported user specific data, wherein the associations define whether user specific data correlates to one or more predefined definitions associated with a given user list;
storing the associations; and
providing user list identifying information to subscribers to a given user list in response to receipt of a content request from a user included in a respective user list.

16. A system comprising:
an advertising server configurable for receiving advertising content requests and providing advertising content to users; and
a data exchange engine operably coupled to the advertising server and configurable to maintain one or more user lists based on owned or permissioned data, wherein the user lists comprise user specific associations between users and a user list definition so as to allow for personalized advertising content to be delivered to users.

17. The system of claim 16, further comprising a plurality of advertisement customizers operable to customize advertising content according to one or more user lists.

18. A method comprising:
receive a request to provide content to a user;
determine user lists associated with the user;
identify subscribers to the determined user lists; and
provide list definition information and the request to a subscriber so that the subscriber may either customize a bid for an impression associated with the request or customize content to be displayed to the user after having won the impression.
